(19) United States
(12) Patent Application Publication
(10) Pub. No.: US 2017/0116582 A1
(43) Pub. Date: Apr. 27, 2017

(54) MAINTENANCE SYSTEM AND METHOD FOR A MACHINE USED IN DRILLING OPERATIONS

(71) Applicant: MHWIRTH AS, KRISTIANSAND (NO)

(72) Inventor: BJARNE LARSEN, KRISTIANSAND (NO)

(73) Assignee: MHWIRTH AS, KRISTIANSAND (NO)

(21) Appl. No.: 15/299,470

(22) Filed: Oct. 21, 2016

(30) Foreign Application Priority Data
Oct. 26, 2015 (NO) 20151453

(51) Int. Cl. G06Q 10/00

(52) U.S. Cl. CPC G06Q 10/20

(57) ABSTRACT

A method for scheduling a maintenance event for a machine used in drilling which includes providing a first well plan for a first well to be drilled over a first time period (t_{A}) and a second well plan for a second well to be drilled over a second time period (t_{B}), controlling a first computer program module for determining a projected first duty profile for the machine in the first time period and a projected second duty profile for the machine in the second time period, controlling a second computer program module for scheduling a maintenance event (t_{M1}) for the machine based on the projected first duty profile and the projected second duty profile, and creating a new maintenance event (t_{M2}) at a time prior to the second time period if the maintenance event (t_{M1}) falls within the second time period.

### CROSS REFERENCE TO PRIOR APPLICATIONS

Priority is claimed to Norwegian Patent Application No. NO 20151453, filed Oct. 26, 2015. The entire disclosure of said application is incorporated by reference herein.

### FIELD

The present invention relates to a maintenance system and a method for a machine used in drilling operations, and in particular to a system and a method for scheduling and carrying out maintenance activities for such a machine.

### BACKGROUND

Drilling is one of the key operations in the exploration and exploitation of petroleum resources. Because easily exploitable resources are dwindling, the industry is moving into harsher and more challenging areas, such as deepwater resources and more challenging reservoirs. This places additional technical demands on the equipment used in such drilling operations. Drilling rigs used in such activities further form a major cost of operation; for example, operating an offshore drilling rig can cost in the order of USD 500,000 per day.

There is therefore a continuous need for improved methods of operating such equipment, including the maintenance of machines used in drilling operations to provide their operational reliability and optimize their utilization. There is in particular a need to schedule maintenance activities so that they have as little influence on rig operations as possible.

### SUMMARY

An aspect of the present invention is to provide an improved maintenance method for drilling machines.

In an embodiment, the present invention provides a method for scheduling a maintenance event for a machine used in drilling operations, the method comprising:

providing a first well plan for a first well to be drilled over a first time period (t_{A}) and a second well plan for a second well to be drilled over a second time period (t_{B});

controlling a first computer program module for determining a projected first duty profile for the machine in the first time period and a projected second duty profile for the machine in the second time period;

controlling a second computer program module for scheduling a maintenance event (t_{M1}) for the machine based on the projected first duty profile and the projected second duty profile; and

if the maintenance event (t_{M1}) falls within the second time period, create a new maintenance event (t_{M2}) at a time prior to the second time period.

### BRIEF DESCRIPTION OF THE DRAWINGS

The present invention is described in greater detail below on the basis of embodiments and of the drawings in which:

FIG. 1 illustrates well progression, load on a machine, and remaining useful lifetime for the machine with the use of a method according to an embodiment of the present invention; and

FIG. 2 illustrates well progression, load on a machine, and remaining useful lifetime for the machine with the use of a method according to an embodiment of the present invention.

### DETAILED DESCRIPTION

In an embodiment of the present invention, the time prior to the second time period can, for example, be within a third time period, the third time period being a time in between wells.

The first and second well plans can, for example, include information about a plurality of sections to be drilled for that well, the information for each section being selected from at least one of: a well depth for the section; a total time planned for drilling the section; a projected drilling progression over that total time; a projected rate-of-penetration for the section; a projected number of drilling sequences for the section; the properties of the formation for the section; a required mud flow rate for the section; required mud properties for the section; a required drill string rotational speed for the section; and a required weight-on-bit for the section.

In an embodiment of the present invention, the step of scheduling a maintenance event (t_{M1}) for the machine based on the projected first duty profile and the projected second duty profile can, for example, include predicting a remaining useful life value for the machine and scheduling the maintenance event at a time where the predicted remaining useful life value drops below a pre-set threshold value.

In an embodiment of the present invention, the method can, for example, further comprise the steps of:

at at least one time (t₁, t₂, t₃) during the first time period, receiving data from sensors representing operational parameters for the machine;

controlling a computer program module for recalculating the maintenance event for the machine based on the projected first duty profile, the projected second duty profile, and the data; and

if the maintenance event falls within the second time period, creating a new maintenance event (t_{M2}) at a time prior to the second time period.

In an embodiment of the present invention, a maintenance method for a machine used in drilling is provided, the maintenance method comprising the steps of scheduling a maintenance event according to one of the embodiments described above, and carrying out a maintenance operation on the machine substantially at the time scheduled for the new maintenance event (t_{M2}).

In an embodiment of the present invention, the method can include the step of outputting the new maintenance event (t_{M2}) on a display to an operator.

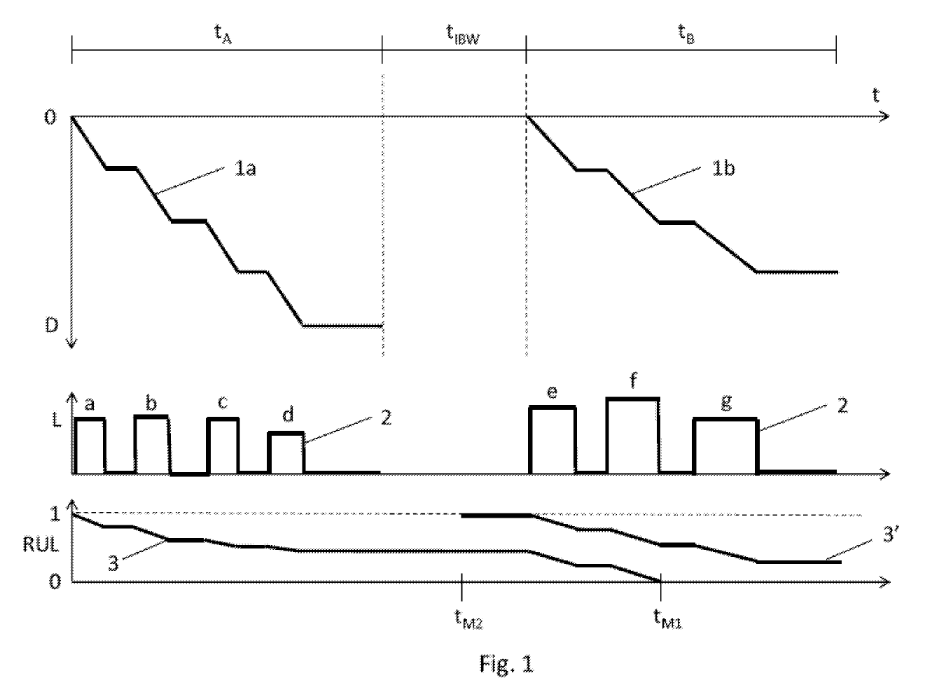

The present invention provides a computer-based method for scheduling a maintenance event for a machine used in drilling operations. The method will now be described in relation to FIG. 1. For this simplified example, it will be assumed that the machine is a top drive/derrick drilling machine (DDM), however, a person skilled in the art will understand that the method of the present invention can be applicable to any machine involved in drilling operations, including but not limited to mud pumps, winches, hoisting cylinders, pipe handling machines, fluid treatment apparatus, torque tongs, etc.

The method includes providing a first well plan for a first well to be drilled over the course of a first time period (t_{A}) and a second well plan for a second well to be drilled over the course of a second time period (t_{B}). The well plan may include a planned progression la and lb for the first and second wells respectively. The planned progression may be expressed in terms of well depth D, as indicated in FIG. 1. The well plan may include various other information and parameters, including, for example, formation characteristics. The well plan may be based on theoretical calculations, computational analyses, measurements, or a combination of these. It may also, alternatively, or in addition, be based on historical data recorded in drilling operations carried out on similar wells.

Based on the well plan, a first duty profile is defined for the drilling machine over the first time period, and a second duty profile is defined for the drilling machine over the second time period. In FIG. 1, the duty profile is shown as a load (L) 2 to which the drilling machine is exposed. The load may represent the power provided by the machine, for example, the rotational speed multiplied with the torque applied to the drill string in the case of the top drive/DDM. The load may alternatively be the number of duty cycles, force, velocity, pressure, or any other operational parameter or combination of operational parameters which influence the wear and/or maintenance intervals of the drilling machine.

For the sake of clear presentation, FIG. 1 illustrates the well progression 1a and 1b for the first and second wells in a simplified manner and only with a small number of drilling sequences. A much larger number of such sequences will in reality be carried out to drill a well. For the first well, four drilling sequences a-d are shown, with a connection sequence between them. In the connection sequence, a new section of pipe will be connected. The well has reached its final depth after the fourth drilling sequence d. The top drive is subject to a load during the drilling sequences a-d, but no load during the connection sequences. The load for the top drive at any given time during t_{A} depends on a number of factors, including drilling speed, formation characteristics, depth of the well, etc.

Three drilling sequences e, f and g are similarly shown for the second well. The second well has different characteristics compared to the first well, which is reflected in the well plan. The projected duty profile for the drilling machine is therefore different than for the first well. The load on the drilling machine is higher for the second well even though the total depth to be drilled is lower.

The method further comprises the step of scheduling a maintenance event t_{M1} for the drilling machine based on the first duty profile and the second duty profile. This can be carried out by calculating a remaining useful life (RUL) 3 for the drilling machine, i.e., the remaining operational life available before maintenance is required. The remaining useful life can be calculated based on the drilling machine duty profile, whereby the RUL is adjusted when the drilling machine is subjected to a load over a certain time. A maintenance operation is required when the remaining useful life 3 is projected to drop below zero.

If the maintenance event t_{M1} falls within the second time period t_{B}, a new maintenance event t_{M2} is created at a time prior to the second time period t_{B}, i.e., prior to commencing drilling on the second well. This requires maintenance to be carried out before the drilling machine has reached the end of its remaining useful life but allows, however, maintenance to be carried out in a time period t_{IBW} between drilling the first and the second well. This changes the value of remaining useful life (RUL) for the drilling machine prior to commencing the second well, and permits the second well to be drilled without the need to stop operations to carry out maintenance. The new RUL is indicated as 3′.

The first and second well plans advantageously include information about a plurality of sections to be drilled for that well and include for each section at least one of: a well depth for the section; a total time planned for drilling the section; a projected well drilling progression over that total time; a projected rate-of-penetration for the section; a projected number of drilling sequences for the section; the properties of the formation for the section; a required mud flow rate for the section; required mud properties for the section; a required drill string rotational speed for the section; and a required weight-on-bit for the section. Table 1 shows an example of a well plan comprising such information.

TABLE 1
Extract from Well Plan

| | | Mud | Mud | | Weight | |
|---|---|---|---|---|---|---|
| | | weight | flow | | on bit | |
| Section | Depth [m] | [ppg] | [gpm] | RPM | [klbs] | Geology |
| 1 | 0-300 | 8.7 | 1400 | 60 | 5 | Pliocene |
| 2 | 300-900 | 12.6 | 1400 | 100 | 20 | Miocene |
| 3 | 900-2200 | 14.6 | 1250 | 120 | 50 | Oligocene |
| 4 | 2200-3800 | 14.7 | 850 | 120 | 40 | Eocene |

Providing a well plan with such information allows the duty profile for the drilling machine to be predicted more accurately and with more granularity, thus allowing a required maintenance event to be predicted earlier. For example, in the example shown in FIG. 1, the higher load during drilling of the second well causes the remaining useful life for the drilling machine to fall under the threshold value during the second time period t_{B}. This may, for example, be due to the geology of the formation, requiring the use of a higher weight-on-bit during drilling, a different mud weight, etc. This would not have been possible to predict by a mere extrapolation of the duty profile or RUL predictions from the first well.

The possibility of scheduling a maintenance event in between wells provides significant advantages in that such maintenance can be carried out while the rig is in transit, and thus at a time when the drilling machine in any case is not in use.

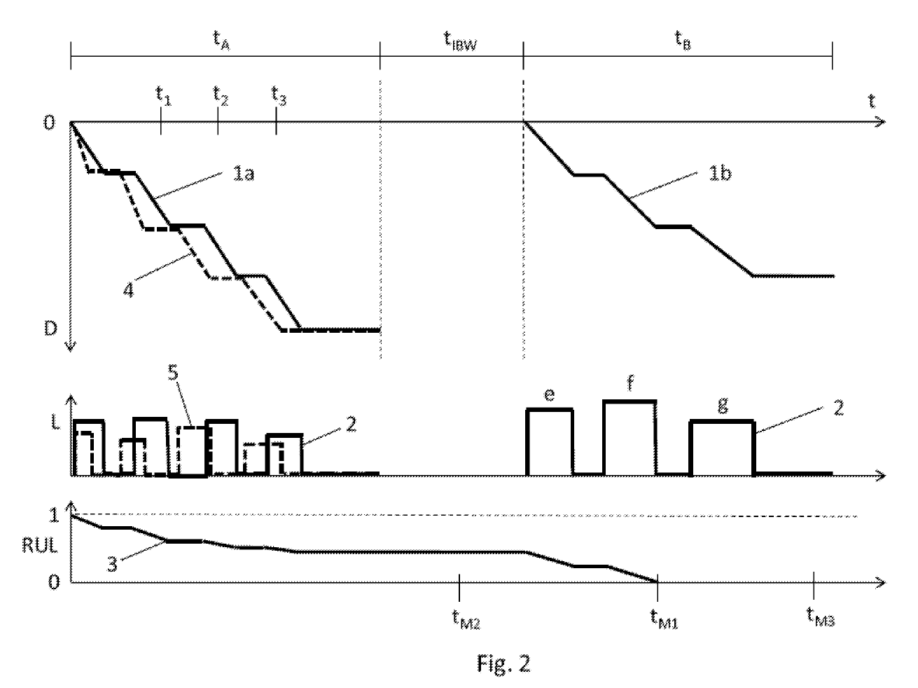

Referring now to FIG. 2, in an embodiment, the method further comprises the steps of: at at least one time t₁, t₂, t₃ during the first time period, receiving data from sensors representing operational parameters for the drilling machine. For example, this may be data representing actual well depth 4 and actual load 5 on the drilling machine.

This permits a recalculation of the maintenance event for the drilling machine based on the projected first duty profile, the projected second duty profile, and the actual operational data available up to that time t₁, t₂, or t₃. In the example shown, drilling of the well turned out to progress quicker than planned, for example, due to less demanding reservoir properties, and the load 5 on the drilling machine was lower during drilling of the first well.

By recalculating the maintenance event based on the projected first duty profile, the projected second duty profile, and the actual operational data, one may have reached, already at time t₃, a projected maintenance event at time t_{M3}, i.e., after the completion of the second well. In this case, the maintenance can thus be postponed and one can progress with the second well with reduced risk of interruption to carry out maintenance.

The method further comprises the step of, at each of the at least one time t₁, t₂, t₃, determining whether the recalculated maintenance event falls within the second time period, and, if that is the case, create a new maintenance event (t_{M2}) at a time prior to the second time period. In the converse situation to that described above, i.e., that the drilling of the first well generates higher than predicted load on the drilling machine, a maintenance event can thus be prepared between the first and second wells. The method according to this embodiment of the invention advantageously allows the new maintenance event, t_{M2}, to be identified early, e.g., already at times t₁, t₂, or t₃. This allows the operator to plan the maintenance more in advance, e.g., prior to completing the first well. This is important because maintenance work on a drilling machine generally requires planning of the work, provision and transport of spare parts and tools, and transport of service personnel on-site (e.g., onboard a drilling rig). Having this information in advance may thus allow maintenance work to be carried out during t_{IBW} without delaying the start of drilling for the second well.

The method can include the step of outputting the new maintenance event (t_{M2}) on a display to an operator. The display may be a dedicated display for this purpose, or a display being part of a drilling management system.

The present invention is not limited to embodiments described herein; reference should be had to the appended claims.

What is claimed is:

1. A method for scheduling a maintenance event for a machine used in drilling, the method comprising:
providing a first well plan for a first well to be drilled over a first time period and a second well plan for a second well to be drilled over a second time period;
controlling a first computer program module for determining a projected first duty profile for the machine in the first time period and a projected second duty profile for the machine in the second time period;
controlling a second computer program module for scheduling a maintenance event for the machine based on the projected first duty profile and the projected second duty profile; and
creating a new maintenance event at a time prior to the second time period if the maintenance event falls within the second time period.

2. The method as recited in claim 1, wherein the time prior to the second time period is within a third time period, the third time period being a time in between wells.

3. The method as recited in claim 1, wherein the first well plan includes information about a plurality of sections to be drilled for the first well, and the second well plan includes information about a plurality of sections to be drilled for the second well plan, the information for each section of the plurality of sections including at least one of:
a well depth for the section;
a total time planned for drilling the section;
a projected drilling progression over the total time planned;
a projected rate-of-penetration for the section;
a projected number of drilling sequences for the section;
the properties of the formation for the section;
a required mud flow rate for the section;
required mud properties for the section;
a required drill string rotational speed for the section; and
a required weight-on-bit for the section.

4. The method as recited in claim 1, wherein the scheduling of the maintenance event for the machine based on the projected first duty profile and the projected second duty profile includes predicting a remaining useful life value for the machine and scheduling the maintenance event at a time where the predicted remaining useful life value drops below a pre-set threshold value.

5. The method as recited in claim 1, the method further comprising:
receiving data from sensors representing measured operational parameters for the machine at at least one time during the first time period;
controlling the second computer program module for recalculating the maintenance event for the machine based on the projected first duty profile, the projected second duty profile, and the data; and
creating the new maintenance event at a time prior to the second time period if the maintenance event falls within the second time period.

6. The method as recited in claim 1, the method further comprising:
outputting the new maintenance event to a display.

7. A computer program product which, when loaded into a memory and executed on a processing device, causes the processing device to perform the method as recited in claim 1.

8. A system for scheduling a maintenance event for a drilling machine, the system comprising:
a computer device configured to perform the method as recited in claim 1.

9. A maintenance method for a machine used in drilling, the maintenance method comprising the steps of:
scheduling a maintenance event according to the method as recited in claim 1; and
carrying out a maintenance operation on the machine substantially at the time scheduled for the new maintenance event.
